(19) United States
(12) Patent Application Publication
(10) Pub. No.: US 2024/0103268 A1
(43) Pub. Date: Mar. 28, 2024

(54) HEAD-UP DISPLAY DEVICE

(71) Applicant: NIPPON SEIKI CO., LTD., Niigata (JP)

(72) Inventors: Takeru KAWAI, Niigata (JP); Yujiro INOUE, Niigata (JP)

(21) Appl. No.: 18/457,782

(22) Filed: Aug. 29, 2023

(30) Foreign Application Priority Data
Sep. 28, 2022 (JP) 2022-154998

(51) Int. Cl. G02B 27/01

(52) U.S. Cl. CPC G02B 27/0101

(57) ABSTRACT

To provide a head-up display device that may reduce distortions of displayed virtual images while reducing loads on a control unit. A head-up display outputs display light to a windshield mounted on a vehicle to display virtual images and includes a display device including a display surface that outputs the display light, and a prism that transmits the display light output from the display surface, and the prism includes an incidence surface on which the display light from the display surface is incident, and an output surface that outputs the display light incident on the prism from the incidence surface.

### TECHNICAL FIELD

The present disclosure relates to a head-up display device.

### BACKGROUND ART

For example, a display device described in Patent Document 1 displays images on a display unit based on control by a control unit. In this case, the control unit outputs previously distorted image data to the display unit based on a warping parameter stored in a storage device to offset the distortion generated by an optical component that projects display light. The control unit also controls warping in a depth direction when controlling the display unit that may perform 3D display.

### PRIOR ART DOCUMENT

### Patent Document

Patent Document 1: Japanese Unexamined Patent Application Publication No. 2022-114602

### SUMMARY OF INVENTION

### Technical Problem

In the configuration described in the above Patent Document 1, the control unit generates a distorted image each time based on the warping parameter, which tends to increase the resources needed for calculations.

The present disclosure has been made in consideration of the above-described actual circumstances and has an object to provide a head-up display device that may reduce distortions of virtual images while reducing loads on the control unit.

### Solution to Problem

In order to achieve the above-described object, a head-up display device according to the present disclosure is a head-up display device that outputs display light to a transmissive reflector mounted on a vehicle to display a virtual image, the head-up display device includes a display device including a display surface that outputs the display light and a prism that transmits the display light output from the display surface, the prism includes an incidence surface on which the display light from the display surface is incident and an output surface that outputs the display light incident on the prism through the incidence surface, a virtual display surface, which is an apparent position of the display surface caused by refraction at the output surface, is formed between the incidence surface and the output surface, and the virtual display surface is formed to reduce a distortion in a depth direction of the virtual image caused by reflection at the transmissive reflector.

In order to achieve the above-described object, a head-up display device according to the present disclosure is a head-up display device that outputs display light to a transmissive reflector mounted on a vehicle to display a virtual image, the head-up display device includes a display device including a display surface that outputs the display light and a prism that transmits the display light output from the display surface, the prism includes an incidence surface on which the display light from the display surface is incident and an output surface that outputs the display light incident on the prism through the incidence surface, a virtual display surface, which is an apparent position of the display surface caused by refraction at the output surface, is formed between the incidence surface and the output surface, and the output surface has a convex shape that is symmetrical in a direction corresponding to a width direction of the virtual image.

### Advantageous Effects of Invention

According to the present disclosure, in a head-up display device, distortions of displayed virtual images may be reduced while reducing loads on a control unit.

### BRIEF DESCRIPTION OF DRAWINGS

FIG. 1 is a schematic view of a head-up display device according to a first embodiment of the present disclosure.

FIG. 2 is a diagram illustrating a virtual image superimposed on a real landscape according to the first embodiment of the present disclosure.

FIG. 3 is a perspective view of a prism and a display device according to the first embodiment of the present disclosure.

FIG. 4 is a longitudinal cross-sectional view of the prism and the display device according to the first embodiment of the present disclosure.

FIG. 5 is a side view of the prism and the display device according to the first embodiment of the present disclosure.

FIG. 6 is a schematic view of the display device, the prism, a concave mirror, and a windshield according to the first embodiment of the present disclosure.

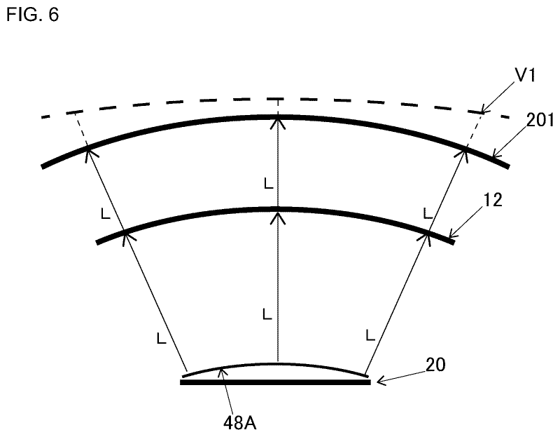

FIG. 7 is a schematic view of the display device, the concave mirror, and the windshield according to a comparative example.

### DESCRIPTION OF EMBODIMENTS

### First Embodiment

A head-up display device according to a first embodiment of the present disclosure will be described with reference to the drawings.

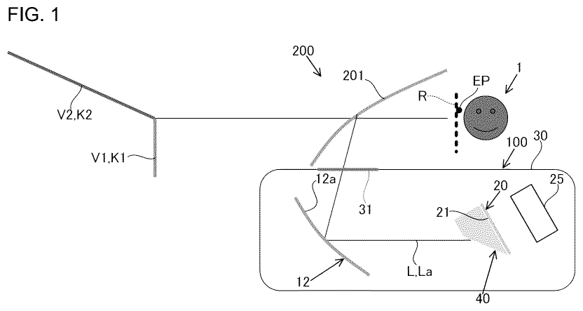

As illustrated in FIG. 1, a head-up display device 100 is mounted under a dashboard of a vehicle 200, for example. The head-up display device 100 projects display light L onto a windshield 201, which is an example of a projected member (transmissive reflector), to display a plurality of virtual images V1, V2 including vehicle information. The virtual images V1, V2 are visible to a viewer 1 when a viewpoint EP of the viewer 1 is within a visible region R. The virtual image V1 is displayed within a virtual image display virtual region K1. The virtual image V2 is displayed within a virtual image display virtual region K2. The virtual image display virtual regions K1, K2 are each formed by formless surfaces and are formed in different directions from each other.

The virtual image display virtual region K1 extends along a height direction. Here, extending along the height direction means that the virtual image display virtual region K1 falls within less than ±45° with respect to the height direction. The virtual image display virtual region K2 exists with an inclination while being continuous to a lower portion of the virtual image display virtual region K1. For example, the virtual image display virtual region K2 extends along a road surface. Here, extending along the road surface means that the virtual image display virtual region K2 falls within less than ±45° with respect to the horizontal direction.

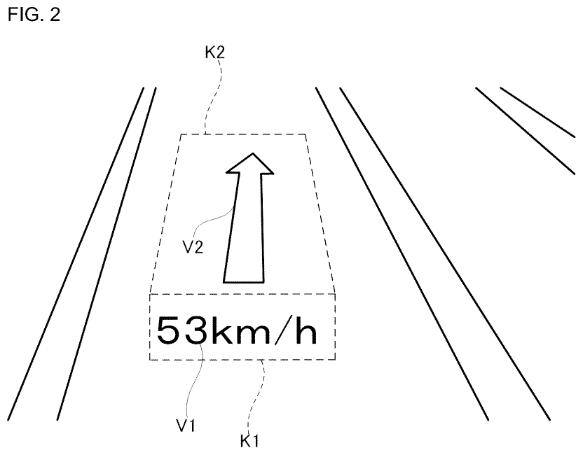

As illustrated in FIG. 2, the virtual image V2 is displayed along the road surface, which is a real scene, when viewed from the viewer 1. The virtual image V1 is displayed standing against the road surface, which is a real scene, when viewed from the viewer 1. The virtual image V2 includes the information associated with the road surface, for example, symbol information such as route guidance arrow. The virtual image V1 includes character information such as vehicle speed or sign information. Characters are numbers, alphabets, hiragana, katakana, kanji, etc.

Furthermore, the virtual image V1 may include the icon indicating a structural object standing on the ground, such as building or tree. By comparison with the icon, it is easy for the viewer 1 to recognize that the display of the virtual image V1 other than the icon is also displayed along the height direction.

Next, a configuration of the head-up display device 100 will be described.

As illustrated in FIG. 1, the head-up display device 100 includes a concave mirror 12, which is an optical relay, a display device 20, a control unit 25, a case 30, and a prism 40, which is an example of a virtual image orientation adjustment means.

The case 30 is formed to have a box-like shape with a light-shielding resin or metal. The case 30 houses the concave mirror 12, the display device 20, and the prism 40. The case 30 includes a window portion 31 made of a light-transmitting member that transmits the display light L generated in the internal space of the case 30 toward the windshield 201.

The display device 20 includes a display surface 21 that emits the display light L representing an image. The display device 20 may be a type with a liquid crystal panel and an illumination device, or a type with a reflective display element such as a DMD (Digital Micro mirror Device) element and a projector. The display surface 21 faces downward toward the front of the vehicle 200. Images displayed on the display surface 21 are subjected to distortion correction to correct the distortion occurring in the in-plane direction of the virtual images V1, V2 viewed by the viewer 1. The distortion correction is called a warping process. The display surface 21 is inclined with respect to an optical axis center La of the display light L. The optical axis center La is located at the center of the transverse section of the display light L.

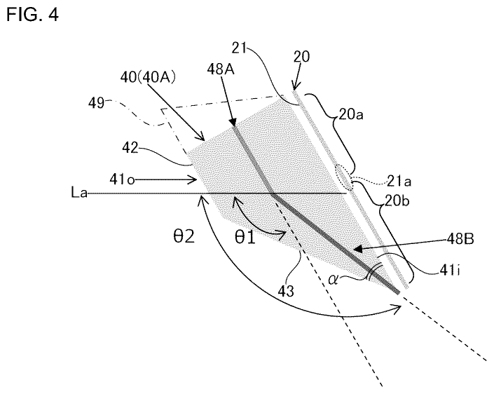

As illustrated in FIG. 4, the display surface 21 includes a first region 20a that outputs the display light L corresponding to the virtual image V1 and a second region 20b that outputs the display light L corresponding to the virtual image V2. The first region 20a displays character information, and the second region 20b displays symbol information. A first virtual display surface and a second virtual display surface are formed in the spaces inside the prism 40 corresponding to the first region 20a and the second region 20b, respectively.

As illustrated in FIG. 1, the control unit 25 includes a CPU (Central Processing Unit), a GDC (Graphics Display Controller), a ROM (Read Only Memory), a RAM (Random Access Memory), etc. The control unit 25 acquires information with regard to the information such as vehicle speed and route guidance from external units and generates images to be displayed on the display surface 21 based on the information.

The prism 40 is installed on the display surface 21 to transmit the display light L output from the display surface 21. The prism 40 will be described below in detail.

As illustrated in FIG. 1, the concave mirror 12 includes a reflective surface 12a that is curved in a concave shape along the height direction and the width direction of the vehicle. The concave mirror 12 reflects the display light L transmitted through the prism 140 toward the windshield 201. The concave mirror 12 reflects the display light L from the display surface 21 toward the windshield 201 so as to augment it. The reflective surface 12a of the concave mirror 12 faces upward toward the rear of the vehicle 200. The concave mirror 12 functions to suppress distortions of virtual images caused by reflection at the windshield 201.

Next, a configuration of the prism 40 will be described.

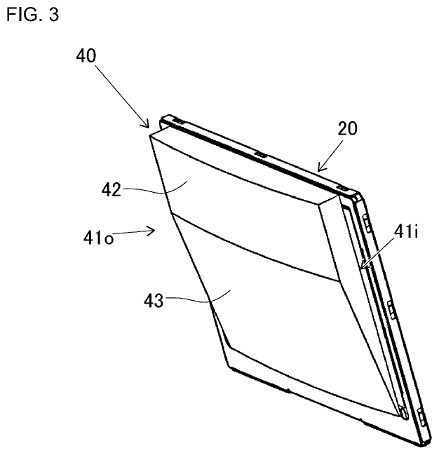

As illustrated in FIGS. 3 and 4, the prism 40 is made of a material, for example, glass or optical resin, having a refractive index n higher than that of air (n=1). The prism 40 is formed to have substantially the shape like a plate that covers the display surface 21.

The prism 40 includes an incidence surface 41i, which is located to face the display surface 21 and on which the display light from the display surface 21 is incident, and an output surface 41o, which is located on the opposite side of the incidence surface 41i and outputs the incident display light L. The incidence surface 41i is formed to have a shape like a rectangular plane. The incidence surface 41i of the prism 40 may be fixed to the display surface 21 by optical bonding, or the prism 40 may be supported by a support mechanism not illustrated.

The prism 40 and the display device 20 have a shape like an elongated plate in the height direction. The prism 40 includes the incidence surface 41i, which is positioned corresponding to the display surface 21 and on which the display light from the display surface 21 is incident, and the output surface 410 that outputs the display light L incident on the prism 40 through the incidence surface 41i. The output surface 410 includes a first top surface 42, which extends along the display surface 21 and has a semi-cylindrical shape, and an inclined surface 43, which is inclined with respect to the first top surface 42 and has a semi-cylindrical shape. The first top surface 42 and the inclined surface 43 are continuous in the height direction. The first top surface 42 is located upward from the inclined surface 43. The inclined surface 43 is inclined toward the display device 20 as it is closer to the lower side. The semi-cylindrical shape of the first top surface 42 and the inclined surface 43 has a convex shape toward the opposite direction of the display device 20. In other words, the first top surface 42 and the inclined surface 43 have a curved shape that is convex in the direction in which the display light L is output.

In the prism 40, a first virtual display surface 48A and a second virtual display surface 48B are formed and located at the center of the prism 40 in the thickness direction. The prism 40 uses the refractive index n of its own to cause the display surface 21 to function as if it were located on the first virtual display surface 48A and the second virtual display surface 48B. Thus, the prism 40 may cause the single display surface 21 to function in the same manner as a plurality of display surfaces. The first virtual display surface 48A is located between the first top surface 42 and the incidence surface 41i and is formed to have a surface shape similar to the first top surface 42. The second virtual display surface 48B is formed between the inclined surface 43 and the incidence surface 41i. The second virtual display surface 48B extends so as to divide an angle α between the incidence surface 41i and the inclined surface 43 into two. The first virtual display surface 48A corresponds to the virtual image display virtual region K1. The second virtual display surface 48B corresponds to the virtual image display virtual region K2.

The optical axis center La of the display light L passes through a boundary portion of the first virtual display surface 48A and the second virtual display surface 48B. Furthermore, the optical axis center La of the display light L may pass through the first virtual display surface 48A and the second virtual display surface 48B instead of passing through the boundary portion.

An angle θ1 of an extended line (the line indicated in a dashed line in FIG. 4) of the first virtual display surface 48A with respect to the optical axis center La is an angle smaller than an angle θ2 of the second virtual display surface 48B with respect to the optical axis center La. The larger the angle θ2 (see FIG. 4), the larger the inclination angle of the virtual image display virtual region K2 with respect to the height direction.

As illustrated in FIGS. 1 and 4, the first virtual display surface 48A corresponds to the virtual image display virtual region K1 along the height direction. The second virtual display surface 48B corresponds to the virtual image display virtual region K2, which is inclined with respect to the virtual image display virtual region K1. An upper edge of the first virtual display surface 48A corresponds to a lower edge of the virtual image display virtual region K1, and a lower edge of the second virtual display surface 48B corresponds to an upper edge of the virtual image display virtual region K2. That is, the respective images of the first virtual display surface 48A and the second virtual display surface 48B are inverted in the height direction and the front-rear direction of the vehicle to be displayed as the virtual images V1, V2.

As illustrated in FIGS. 1 and 2, the virtual image display virtual region K2 is located above the virtual image display virtual region K1 when viewed from the viewer 1. The upper edge of the virtual image display virtual region K1 abuts the lower edge of the virtual image display virtual region K2. The virtual image display virtual region K2 is inclined upward as it is away from the viewer 1.

(With Regard to Top Surface Shape)

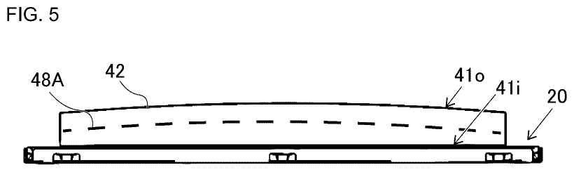

FIG. 5 is a diagram illustrating an external appearance of the prism 40 and the display device 20 in plan view from the height direction. The output surface 42o includes the first top surface 42 having a curved shape in this viewpoint. The virtual display surfaces 48A, 48B have been described above based on their shapes in plan view from the vehicle width direction. However, the actual virtual display surfaces 48A, 48B have curved shapes illustrated in the dotted line in the drawing due to the shapes of the first top surface 42 and the inclined surface 43.

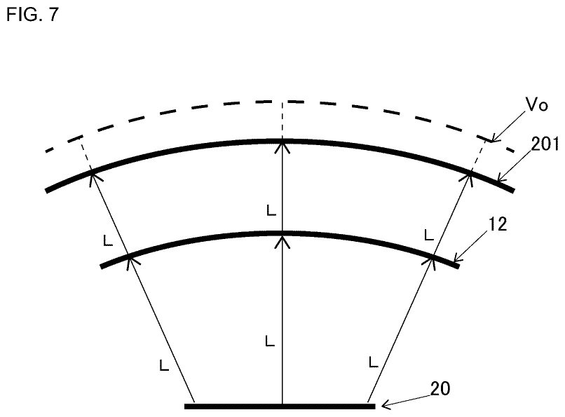

Here, a conventional configuration will be described with reference to FIG. 7. FIG. 7 is a diagram schematically illustrating a configuration of a head-up display including the display device 20, the concave mirror 12, and the windshield 201 when viewed downward in the vertical direction. The head-up display does not include the prism 40.

The display light L is output from the display device 20 including the display surface having a rectangular plane. The display light L reaches the visible region after being reflected by the concave mirror 12 and the windshield 201. Simultaneously, a virtual image Vo, which is visible from the visible region, is formed in front of the windshield 201.

In this case, as illustrated in FIG. 7, the virtual image Vo is curved and formed as the dotted line in the drawing. Specifically, when reflected by the concave mirror 12 and the windshield 201, both of which have concave reflective surfaces, both ends of the virtual image Vo are formed at positions closer to the visible region than the center position. This occurs because the outer optical path length is extremely short when the inner optical path length and the outer optical path length are compared with each other in a case where the concave mirror 12, which has a concave reflective surface, and the windshield 201, which also has a concave reflective surface, are grounded to face each other.

Thus, even when the display surface is a plane, the virtual image is not necessarily formed as a plane, and a distortion may occur in the depth direction of the virtual image.

Some conventional technologies are configured to perform a warping process on the image displayed on the display device and thus reduce distortions in the plane of the virtual image, but it is difficult to reduce distortions in the depth direction of virtual images unless the display device capable of stereoscopic display is used.

Therefore, the head-up display device is configured as in the present embodiment of the present disclosure. Specifically, in the head-up display device 100, the prism 40 includes the incidence surface 41i on which the display light L from the display surface 21 is incident and the output surface 410 that outputs the display light L incident on the prism 40 through the incidence surface 41i, the virtual display surfaces 48A, 48B, which are apparent positions of the display surface 21 caused by refraction at the output surface 41o, are formed between the incidence surface 41i and the output surface 41o, and the virtual display surfaces 48A, 48B are formed to reduce distortions in a depth direction of the virtual images V1, V2 caused by reflection at the windshield 201.

According to the first embodiment, the virtual display is convex in the output direction of the display light L (i.e., convex toward the visible region R) due to the effect of the prism 40. Virtual images are supposed to be distorted so as to be concave toward the visible region R due to the reflection of the optical relay (the concave mirror 12 and the windshield 201) excluding the prism, such a head-up display may reduce distortions in the depth direction of the virtual images V1, V2.

Furthermore, according to another aspect, in the head-up display device 100, the prism 40 includes the incidence surface 41i on which the display light L from the display surface 21 is incident and the output surface 410 that outputs the display light L incident on the prism 40 through the incidence surface 41i, the virtual display surfaces 48A, 48B, which are apparent positions of the display surface 21 caused by refraction at the output surface 41o, are formed between the incidence surface 41i and the output surface 41o, and the output surface 410 has a convex shape in a direction corresponding to a width direction of the virtual images V1, V2.

According to the first embodiment, the virtual display is convex in the output direction of the display light L (i.e., convex toward the visible region R) due to the effect of the prism 40. Virtual images are supposed to be distorted so as to be concave toward the visible region R due to the reflection of the optical relay (the concave mirror 12 and the windshield 201) excluding the prism, such a head-up display may reduce distortions in the depth direction of the virtual images V1, V2. Furthermore, the convex shape is preferably symmetrical in the direction corresponding to the width direction. This configuration allows the use of a common member regardless of whether the vehicle is a right-hand drive vehicle or a left-hand drive vehicle, which results in a head-up display device with desirable manufacturability.

In addition, such a convex shape that is symmetrical in the direction corresponding to the width direction of the virtual images V1, V2 is particularly suitable for a head-up display mounted on a vehicle because the common prism 40 may be used even when the position of the steering wheel of the vehicle 200 is shifted to right or left with respect to the center.

Furthermore, the present disclosure is not limited to the embodiment and the drawings described above. Changes (also including deletion of components) may be made as appropriate without changing the scope of the present disclosure. An example of modifications will be described below.

(Modifications)

According to the above embodiment, the prism 40 including the inclined surface 43 is described, but this is not a limitation, and the entire output surface 410 may be configured as the first top surface 42.

According to the above embodiment, the first top surface 42 and the inclined surface 43 whose curved surfaces have uniform curvatures are described, but this is not a limitation, and the curvatures may be changed partially or entirely. In particular, typically, the curvature of the windshield on the upper side is relatively large. Therefore, it is possible to reduce distortions more effectively when the portion of the output surface 410 corresponding to the above-described area has a high curvature.

According to the above embodiment, the display light L is directly emitted from the display surface 21 to the concave mirror 12, but this is not a limitation, and a correction mirror or a plane mirror may be newly provided to reflect the display light L emitted from the display surface 21 toward the concave mirror 12. The correction mirror is, for example, a concave mirror having a concave shape in longitudinal cross-section. The correction mirror and the concave mirror 12 may constitute an optical relay that guides the display light L from the display surface 21 to the windshield 201.

According to each of the above embodiments, the concave mirror 12 may be configured to rotate around the rotation axis extending along the vehicle width direction. The rotation of the concave mirror 12 around the rotation axis adjusts the height at which the display light L is projected to the viewer 1.

According to the above embodiment, the configuration may be such that the display light L is not output from a hidden region 21a corresponding to the boundary portion of the virtual display surfaces 48A, 48B in the display surface 21. This suppresses the display from moving back and forth between the virtual images V1, V2 when the viewpoint of the viewer is moved within the visible region, and thus the sense of discomfort given to the viewer may be reduced.

Furthermore, this modification is not a limitation, and a light-shielding means such as a light-shielding member may be used to have a configuration so as to prevent the display light L from reaching the boundary portion of the virtual display surfaces 48A, 48B.

The above-described prism 40 may be made of ulexite, i.e., TV rock. This may form a virtual display surface on a light output surface of the prism 40.

A prism 40A may include a protrusion 49 that protrudes from the display surface 21 as indicated in a single-dotted line in FIG. 4. The protrusion 49 transmits the light that is included in the display light L and travels from the display surface 21 toward the upper end portion of the concave mirror 12. The protrusion 49 is provided on an upper side surface of the prism 40 according to the above embodiment and is formed such that its height becomes higher as it is closer to the output surface 410 from the display surface 21. Thus, it is possible to effectively use the entire region of the reflective surface 12a of the concave mirror 12 and increase the size of the virtual image display virtual region K1.

Furthermore, the edge portion between the top surface and the inclined surface of the above prism 40 may be rounded.

The top surface portion and the inclined surface portion of the above prism 40 may be formed separately.

According to each of the above embodiments, the head-up display device 100 is mounted on, but not limited thereto, the vehicle, and may be mounted on vehicles such as airplanes or ships. Furthermore, the projected member is not limited to the windshield 201, but may be a dedicated combiner.

Further, the display light L may be crossed in an optical path by the convergence effect of mirrors or lenses.

Even in this case, the effect of the present invention may be achieved when the prism and the display device are configured as appropriate for the desired form of virtual images.

For example, when the display light L is crossed once in the optical path in the vertical direction, the prism or the display device may be installed upside down, as compared with the case where it is not crossed.

### REFERENCE SIGNS LIST

1 Viewer
12 Concave mirror
20 Display device
21 Display surface
21a Hidden region
25 Control unit
30 Case
31 Window portion
40 Prism
41i Incidence surface
41o Output surface
42 First top surface
43 Inclined surface
48A, 48B Virtual display surface
49 Protrusion
100 Head-up display device
200 Vehicle
201 Windshield
205 Viewpoint detection unitα, θ1, θ2 Angle
C Centerline
L Display light
K1, K2 Virtual image display virtual region
R Visible region
V1, V2 Virtual image
X Horizontal axis
Z Vertical axis
EP Viewpoint
La Optical axis center

1. A head-up display device that outputs display light to a transmissive reflector mounted on a vehicle to display a virtual image, the head-up display device comprising:
a display device including a display surface that outputs the display light; and
a prism that transmits the display light output from the display surface, wherein
the prism includes
an incidence surface on which the display light from the display surface is incident, and
an output surface that outputs the display light incident on the prism through the incidence surface,
a virtual display surface, which is an apparent position of the display surface caused by refraction at the output surface, is formed between the incidence surface and the output surface, and
the virtual display surface is formed to reduce a distortion in a depth direction of the virtual image caused by reflection at the transmissive reflector.

2. A head-up display device that outputs display light to a transmissive reflector mounted on a vehicle to display a virtual image, the head-up display device comprising:
a display device including a display surface that outputs the display light; and
a prism that transmits the display light output from the display surface, wherein
the prism includes
an incidence surface on which the display light from the display surface is incident, and
an output surface that outputs the display light incident on the prism through the incidence surface,
a virtual display surface, which is an apparent position of the display surface caused by refraction at the output surface, is formed between the incidence surface and the output surface, and
the output surface has a convex shape in a direction corresponding to a width direction of the virtual image.

3. The head-up display device according to claim 2, wherein the output surface has a convex shape that is symmetrical in the direction corresponding to the width direction of the virtual image.

4. The head-up display device according to claim 1, wherein
the output surface includes
a first top surface extending in a direction along the display surface, and
an inclined surface that is inclined with respect to the first top surface.

5. The head-up display device according to claim 4, wherein
the display surface includes
a first region that outputs the display light passing through the first top surface, and
a second region that outputs the display light passing through the inclined surface,
the first region displays character information, and
the second region displays symbol information.

6. The head-up display device according to claim 4, wherein
a first virtual display surface is formed between the first top surface and the incidence surface of the prism,
a second virtual display surface is formed between the inclined surface and the incidence surface of the prism, and
the display surface includes a hidden region that hides a region corresponding to a boundary portion between the first virtual display surface and the second virtual display surface.
